(19) United States
(12) Patent Application Publication
(10) Pub. No.: US 2008/0185405 A1
(43) Pub. Date: Aug. 7, 2008

(54) FLEXIBLE POUCH WITH A TAMPER-EVIDENT OUTER CAP FITMENT AND METHOD OF FORMING

(75) Inventor: R. C. Murray, Lakewood Ranch, FL (US)

Correspondence Address: GIFFORD, KRASS, SPRINKLE,ANDERSON & CITKOWSKI, P.C, PO BOX 7021, TROY, MI, 48007-7021, US

(73) Assignee: POUCH PAC INNOVATIONS, LLC, Sarasota, FL (US)

(21) Appl. No.: 12/062,125

(22) Filed: Apr. 3, 2008

Related U.S. Application Data
(63) Continuation-in-part of application No. 11/742,193, filed on Apr. 30, 2007.
(60) Provisional application No. 60/795,860, filed on Apr. 28, 2006.

(51) Int. Cl. B67D 3/00

(52) U.S. Cl. 222/525; 222/522

(57) ABSTRACT

A tamper-evident outer cap for a tube spout fitment with push-pull cap for a flexible pouch is provided. The tube spout fitment is sealed to the pouch body, and includes a base portion having a seal-engaging surface disposed within the pouch body and a centrally located passageway. An internal tubular spout projects upwardly from the base portion and has a centrally located passageway. A push-pull cap is slidably retained on the internal tube spout, and is a generally cylindrical member having an outer wall, an inner wall parallel to the outer wall, and an upper wall having a central opening formed therein interconnecting the outer wall to the inner wall. A tamper-evident outer cap is disposed over the push-pull cap, and includes an openable portion, a collar portion permanently retained on the tube spout fitment, and a first connecting member interconnecting the openable portion and the collar portion.

### RELATED APPLICATION

This application is a continuation-in-part of U.S. patent application Ser. No. 11/742,193 filed Apr. 30, 2007, which claims priority of U.S. Provisional Patent Application Ser. No. 60/795,860 filed Apr. 28, 2006, which is incorporated herein by reference.

### BACKGROUND OF THE INVENTION

1. Field of the Invention

The present invention relates generally to a flexible pouch for packaging a product and, more specifically, to a flexible pouch with a tube spout and tamper-evident outer cap for packaging a product and a method of manufacturing the same.

2. Description of the Related Art

Various types of disposable, portable containers are known in the art for storing a fluid or dry product, such as a liquid, granular material, powder or the like. Examples of containers include a cup, a metal can, a plastic bottle, a glass bottle or a flexible pouch. Consumers prefer the convenience of flexible pouches over other types of containers due to their shape, size, shelf life and storage adaptability. Manufacturers recognize the packaging benefits of a flexible pouch, since the pouch can be formed and filled on the same manufacturing line. An example of a method and apparatus for filling a flexible pouch with a product is disclosed in commonly assigned U.S. Pat. No. 6,199,601, which is incorporated herein by reference.

Flexible pouches have been used for some time to distribute various products, including non-carbonated and carbonated products. An example of a pouch for a carbonated beverage is disclosed in commonly assigned PCT Patent Application No. PCT/US03/034396, which is incorporated herein by reference.

The flexible pouch is made from a flexible material, preferably an extrusion or a laminate composed of sheets of plastic or aluminum or the like. An outer layer of the material may include preprinted information, such as a logo or the like, to provide the consumer with information regarding the contents of the pouch. The pouch may be formed and/or filled using conventionally known manufacturing techniques, such as a horizontal form-fill-seal machine with a single or multiple lanes, a flat bed pre-made pouch machine, a vertical form-fill machine, or the like. An example of a method and apparatus for filling a flexible pouch with a product is disclosed in commonly assigned U.S. Pat. No. 6,199,601, which is incorporated herein by reference.

The pouch includes a panel that forms a front wall and a back wall. Edges of the front and back walls, such as an upper edge, lower edge or side edge, are joined together using a sealing technique such as bonding or welding. The pouch includes a dispensing means for removing the product from the pouch. Various types of dispensing means are known in the art. A straw works well for a single use pouch containing a liquid product. The pouch includes a covered straw hole in the pouch wall that is pierceable to access the contents of the pouch. Another type of dispensing means is a resealable zipper. Still another type of dispensing means is a fitment that includes a spout and a cap.

While existing spout and cap fitments work, manufacturing costs may limit their use. In addition there may be environmental or health concerns associated with these types of dispensing means that further constrain their usage. Thus, there is a need in the art for a flexible pouch with a tamper-evident spout fitment, and an improved method of making and filling a flexible pouch with a tamper-evident spout fitment, that can be used to store and dispense various types of products.

### SUMMARY OF THE INVENTION

Accordingly, the present invention is an improved flexible pouch with a tamper evident tube spout fitment and push-pull cap and a method for manufacturing the pouch. The pouch includes a panel having a front wall and a back wall. In an example, a tube spout fitment is sealed between the front wall and back wall. The tube spout fitment includes a base portion having a seal-engaging surface that is disposed between the front wall and the back wall, and a centrally located passageway. An internal tube spout projects upwardly from the base portion and has a centrally located passageway that is continuous with the base portion passageway. A push-pull cap is disposed on the internal tube spout that is moveable between a closed position and an open position. The cap is a generally cylindrical member having an outer wall, an inner wall that is parallel to the outer wall, and an upper wall having an opening formed therein. A tamper-evident outer cap is disposed over the push-pull cap, and includes an openable portion, a collar portion permanently retained on the tube spout fitment, and a first connecting member interconnecting the openable portion and the collar portion.

One advantage of the present invention is that a flexible pouch with a tamper-evident spout fitment and an improved method of making the flexible pouch is provided. Another advantage of the present invention is that a flexible pouch and method of making a flexible pouch is provided that utilizes less material for the spout fitment. Still another advantage of the present invention is that a flexible pouch and the method of making a flexible pouch is provided that is more cost effective to manufacture since it eliminates work stations in the fill/seal process. A further advantage of the present invention is that a flexible pouch and method of making a flexible pouch is provided that includes a tube spout fitment heat or ultrasonically sealed to the walls of the pouch. Still a further advantage of the present invention is that the pouch can be filled directly through the tube spout. Yet a further advantage of the present invention is that the tube spout with push-pull cap is environmentally friendly, since the cap remains on the fitment. Still yet a further advantage of the present invention is that the tube spout fitment has an integral tamper-evident outer cap.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is an elevational view of a flexible pouch with an external tube cap and internal tube spout fitment, according to the present invention.

FIG. 2 an elevational view of the flexible pouch with an external tube cap and internal tube spout fitment of FIG. 1 with the external tube peeled away, according to the present invention.

FIG. 3 is an elevational view of the flexible pouch of FIG. 1 with an ultrasonic seal to seal the fitment to pouch, according to the present invention.

FIG. 4 is an elevational view of the ultrasonically sealed fitment of FIG. 3 with the external sleeve peeled away, according to the present invention.

FIG. 5 is an elevational view of a nonremovable external tube cap and internal tube spout type fitment in a closed position, according to the present invention.

FIG. 6 is a top view of the nonremovable tube cap and internal tube spout fitment of FIG. 5, according to the present invention.

FIG. 7 is an elevational view of a nonremovable external tube cap and internal tube spout type fitment of FIG. 5 in an open position, according to the present invention.

FIG. 8 is an elevational view of a nonremovable external tube cap and internal tube spout type fitment in a closed position, according to the present invention.

FIG. 9 is a top view of the nonremovable tube cap and internal tube spout fitment of FIG. 8, according to the present invention.

FIG. 10 is an elevational view of the nonremovable external tube cap and internal tube spout fitment of FIG. 8 in an open position, according to the present invention.

FIG. 11 is an exploded view of the nonremovable external tube cap and a fitment according to the present invention.

FIG. 12 is a flowchart of a method of forming a flexible pouch with a spout fitment, according to the present invention.

FIG. 13 is a schematic top view of a rotary fill machine according to the present invention.

FIG. 14 is an elevational view of another example of a tamper-evident fitment in a closed position, according to the present invention.

FIG. 15 is an elevational view of the tamper-evident fitment of FIG. 14 in an open position, according to the present invention.

FIG. 16 is a sectional view of the tamper-evident fitment of FIG. 14 in a closed position, according to the present invention.

FIG. 17 is a perspective view of the internal tube spout for the tamper-evident fitment of FIG. 14, according to the present invention.

FIG. 18 is a perspective view of the push-pull cap for the tamper-evident fitment of FIG. 14, according to the present invention.

FIG. 19 is an elevational view of the outer cap for the tamper-evident fitment of FIG. 14, according to the present invention.

### DESCRIPTION OF THE PREFERRED EMBODIMENT(S)

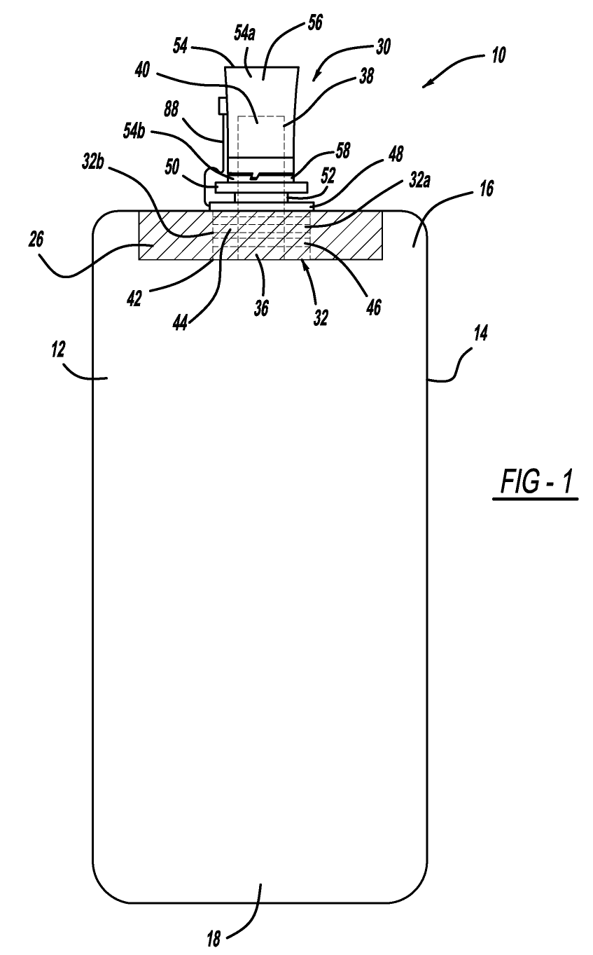

Referring to FIGS. 1-4, a flexible pouch 10 is illustrated. The pouch 10 may be filled with a product and sealed. Various shapes are contemplated for the pouch. The pouch 10 may have a generally cylindrical shape, a box-like shape, an hourglass shape, a barrel shape or another shape. It is contemplated that the pouch may contain a single portion or multiple portions of the product. In this example, the product is a beverage having an alcoholic content, such as wine, beer or liquor, or the like. The product may be carbonated, such as a sparkling wine. An example of a pouch for a carbonated beverage is disclosed in commonly assigned PCT Patent Application No. PCT/US03/034396, which is incorporated herein by reference.

The flexible pouch 10 is preferably formed from a roll of preprinted material of extruded or laminate layers. The material is typically a three, or four, or five or more gauge material, or two laminations of material or the like. The outer layer is usually preprinted. Alternatively, at least a portion of the material may be not printed, i.e. translucent, in order to view the product contained therein. The clear portion could also be in a gusset or insert. The outer layer of material may be a sleeve with preprinted information. In addition, more than one laminate material may be used.

The choice of sheet layer material is non-limiting, and is influenced by factors such as the product contained in the pouch, the shape of the pouch, or the anticipated use of the pouch. One example of a laminate material structure includes at least one layer of virgin polyethylene terephthalate (PET), at least one layer of aluminum foil and another layer such as EVOH, PET, polyethylene or nylon or the like. Another type of laminate material structure may also include a metalized foil paper layer laminated to a cast polypropylene layer and another layer of PET, polyethylene or EVOH. There may be a fourth layer of nylon. Similarly, the laminate structure may include a cast polypropylene (CPP) layer, a polyethylene (PET) layer, a foil (AL) layer, a nylon (ONO) layer and another CPP layer. Another structure is the use of nylon, foil, nylon and cast polypropylene (ONO/AL/ONO/CPP) or CPP/NY/AL/CPP. Another example of a material structure is ONO/AL/COEX-ONO-LDPE. Still another is PET/AL/NYLON/CPP. Material structures that include CPP are well suited for packaging a beverage having an alcoholic content, such as wine or beer or another liquor, to add strength to the walls of the pouch, and to preserve the product. CPP and nylon protect the AL layer from cracking. Carbonation is beneficial since it acts as a microbiocide and preserves the flavor and aroma of the products. The use of cast polypropylene laminate material also assists in retaining the filled shape of the container, even as the product is removed from the pouch 10. A further example of a laminate material structure is CPP/AL/ONO/PE. This structure works well when the product has a short shelf life, and the nylon eliminates stretching or cracking of the AL layer.

For white wine, an example of a material structure is PET/EVOH/PE or AL/PET/NY/PE. Similarly, a material structure for red wine includes PET/EVOH/PE, or AL/NY/PET/PE. Still another example of a material structure is a seven-layer structure that includes a co-extruded laminate, such as PET/CO-PP/AL/NY/LLDPE, or the like. It should be appreciated that the CO-PP layer can include multiple layers, such as three in this example. Other film structures may also be utilized that offer similar protection from sunlight, as well as organoleptic protection from the development of undesirable flavors.

It should be appreciated that if the filled carbonated pouch is stored at ambient temperature, the laminate will start to creep after a period of time, such as ten days. The laminate material may include an extrusion layer to contain “creepage” or “stretch” of the film after filling due to carbonation expansion of the carbonated product. In addition, the selected material may be organoleptic compliant in order to avoid the transfer of odor contaminates to the product, or product contamination during the shelf life period of the product.

The pouch 10 is formed from at least one panel of material. The panel has an inner surface that is adjacent the product, and an outer surface. The pouch formed out of the panel has a front wall 12 and a back wall 14. Each wall 12, 14 is further defined by an upper edge 16, an opposed lower edge 18, and first and second side edges extending therebetween the upper and lower edges 16, 18. The side edges of the panel form a sealed seam. In addition, the side edge, such as the second side edge, may include an angled portion. The pouch may include two side seams if made from two panels or one side seam if made from one panel. In an example of a pouch formed using a single panel of material, the side edges may be joined along a center seam. The seam may be a flat seam.

The pouch 10 may include an insert, sidewall or gusset. The gusset may be integrally formed in the panel, or a separate piece of material. The insert, sidewall or gusset material may be a different structure than that of the pouch body. The gusset may be disposed between the front and back walls 12, 14, and positioned between the side edges of the walls, the lower edges, the upper edges, or any desired combination. It should be appreciated that the shape of the gusset is non-limiting. For example, the gusset may be generally wider at one end and taper upwardly towards the opposite end. The gusset may also be of a uniform width. The use of the gusset may be functional, i.e. it may allow the pouch 10 to acquire another shape, such as cylindrical, or to stand upright. The gusset also enhances the strength and rigidity of the pouch 10 during filling and processing. A side gusset is advantageous since it allows the walls of the pouch to expand as the internal pressure within the pouch increases. A gusset positioned between the lower edges 18 of the pouch 10 may form a base, enabling the pouch 10 to stand upright unsupported.

Similarly, the pouch may include an insert. The insert is a generally planar member that is inserted between the walls 12, 14 of the pouch 10. The shape of the insert is non-limiting, i.e. square, round or oval or rectangular, and generally influences the shape of the flexible pouch. The insert may be positioned internally within the pouch or externally. Various materials may be utilized for the insert, such as foil, cardboard, plastic, nylon, laminate or the like. Further, the insert may be formed from a printed material, or it may be clear. In one example, the insert is inserted between the lower edges of the panel and sealed to the walls of the panel. The seal may be an ultrasonic seal or a heat weld or a combination of both or the like. The insert may include an integral opening means, such as a fitment.

The pouch 10 incorporates an opening means for accessing the contents of the pouch. Various types of opening means are known in the art for this purpose, and is non-limiting. The position of the opening means is determinable by many factors, such as type of opening means. The opening means may be positioned in an upper edge, a lower edge or side edge, or front wall or back wall, or on an insert or gusset. It should be appreciated that the opening means may be incorporated into the pouch 10 prior to filling the pouch 10.

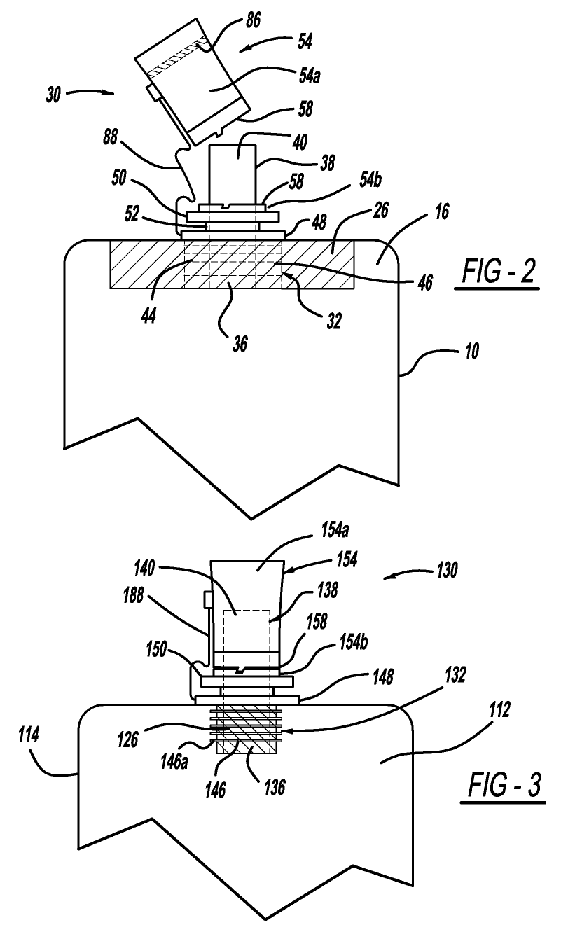

Referring to FIGS. 1-4, the opening means is a tube spout fitment 30 that includes a removable cap for containing the product within the pouch. As shown in FIGS. 1 and 2, the fitment 30 includes a canoe-shaped base 32, and a tube style spout 38 projecting upwardly from the base 32. The base portion 32 includes a centrally located passageway 36 extending through the center of the fitment, to provide access to the contents of the pouch.

The base portion 32 includes a front wall 32a and joined to a back wall 32b, so that the base has a generally elongated shape, such as a diamond, or canoe or elliptical shape or the like. An outer surface of the base portion walls forms a seal-engaging surface 44. The seal-engaging surface may be smooth. In another example, the seal-engaging surface has a plurality of outwardly projecting ribs 46 encircling the front wall and back wall, with each rib 46 spaced a predetermined distance apart. The ribs 46 project outwardly a predetermined distance, in order to provide an increased retention surface for the fitment between the walls of the pouch. The seal-engaging surface 44 is fixedly retained within the walls 12, 14 of the flexible pouch 10 when the walls of the pouch are sealed. A lower edge of the base portion 32 may include an integrally formed lip 42. The elongated shape provides an additional gripping surface for the seal. The outermost edge of each wall may include a vertically extending flange (not shown), that also increases the area of the seal-engaging surface. The fitment 30 is sealed between the upper edges 16 of the pouch wall in a manner to be described.

An internal tube spout 38 projects upwardly from the base portion 32. The internal tube spout 38 is generally cylindrical in shape, and includes a centrally located passageway 40 that is continuous with the central passageway 36 of the base portion 32. A lower end of the internal tube spout 38 includes at least one flange or collar 48 that extends radially a predetermined amount. The flange 48 is positioned adjacent the seal-engaging surface of the base portion 32. A second flange 50 may be positioned a predetermined distance above the first flange 48. A portion of the internal tube spout 38 located between the first flange 48 and a second flange advantageously provides a gripping surface, as shown at 52 for a holding means during the manufacturing operation. The holding means is used to transport or support the pouch during various manufacturing operations, such as opening, filling, or sealing or the like. The second flange 50 may also serve as a “stop” for the cap in a manner to be described.

The internal tube spout 38 may include additional features, such as a plurality of ribs 28 encircling the outer surface of the tube, just above the flange, to assist in retaining the cap on the spout. In one example, the ribs are oriented vertically, and spaced a predetermined distance apart, to retain a “push-on” style cap. In another example, the rib is a horizontally oriented ring. In addition, the upper, open end of the spout may include a removable seal, to prevent leakage of the product or provide evidence of tampering.

A removable external tube or sleeve 54 is secured to the spout 38, in order to seal the pouch. The external tube 54 is generally cylindrical in shape, with a central passageway 56 for receiving the internal tube spout 38. The external tube 54 includes a separating means 58 that divides the external tube 54 into a removable portion 54a and a retained portion 54b. For example, a lower end of the external tube includes a line of weakening 58, and the tube 54 is separated from the spout 38 along this line of weakening 58. An example of a line of weakening 58 is a thin walled section of material that breaks upon the application of a force, so that the removable portion 54a of the external tube 54 is removed from the internal tube 38, and retained portion 54b of the external tube 54 remains secured to the internal tube 38. An inner surface of the lower end of the tube may include a plurality of ribs spaced a predetermined distance apart to assist in gripping the external tube 54 onto the internal tube spout 38.

An upper open end of the external tube 54 is sealed, as shown in FIG. 2 at 86 to prevent the product from leaking out of the pouch. The seal 86 may be a heat seal or an ultrasonic seal. The removable portion 54a of the external tube 54 may be peeled away from the internal tube spout 38 along the line of weakening 58, so that the product is accessible via the internal tube spout 38. The retained portion 54b of the tube remaining on the spout 38 may serve as a tamperproof feature.

In another example, the inner surface of the retained portion 54b of the external tube 54 includes a continuous horizontally oriented rib to assist in retention on the internal spout 38. In still another example, a cord 88 having one end attached to the external tube 54 and a second end attached to the internal tube spout 38 can be utilized to retain the removable portion 54a of the external tube 54 on the fitment 30 after removal from the internal tube spout 38. In an alternative example, the external tube 54 may have a tab that is pulled to sever the connecting walls 58 to remove the external tube 54 from the internal tube spout 38. The retained portion 54a of the external tube 54 may also include a plurality of apertures, as a safety feature.

The base portion 32 of the fitment 30 is heat sealed between the walls 12, 14 of the pouch 10, using a sealing means 26, such as an ultrasonic seal or a heat weld, or the like in order to provide a secure seal. It should be appreciated that the size of the base portion 32 may be reduced, relative to the comparably sized heat-sealed base portion, if an ultrasonic seal is utilized. Advantageously, the symmetrical shape of the seal-engaging portion 44 allows for enhanced precision in positioning the fitment 30 between the walls 12, 14 of the pouch 10.

The external tube 54 and internal tube spout 38 can be fabricated from a variety of materials. For example, the external tube 54 may be made from plastic, such as reground resins. The internal tube spout 38 may be made of food grade polyethylene PE, or polypropylene PP or another type of heat sealable plastic, depending on the product.

In operation, the external tube 54 is pushed onto the internal tube spout 38 and retained by the engagement of the retained portion 54a of the external tube 54 with a gripping means 64 of the internal tube spout. The second flange 50 provides a stop for positioning the external tube 54 relative to the internal tube 38. The external tube 54 and internal tube spout 38 may include other engagement features, as previously described. To remove the external tube 54, the user applies a force to the removable portion 54a of the external tube 54, to sever the thin walled section 58 and peel away from the internal tube spout 38. The internal spout 38 and contents of the pouch 10 are accessible to a user.

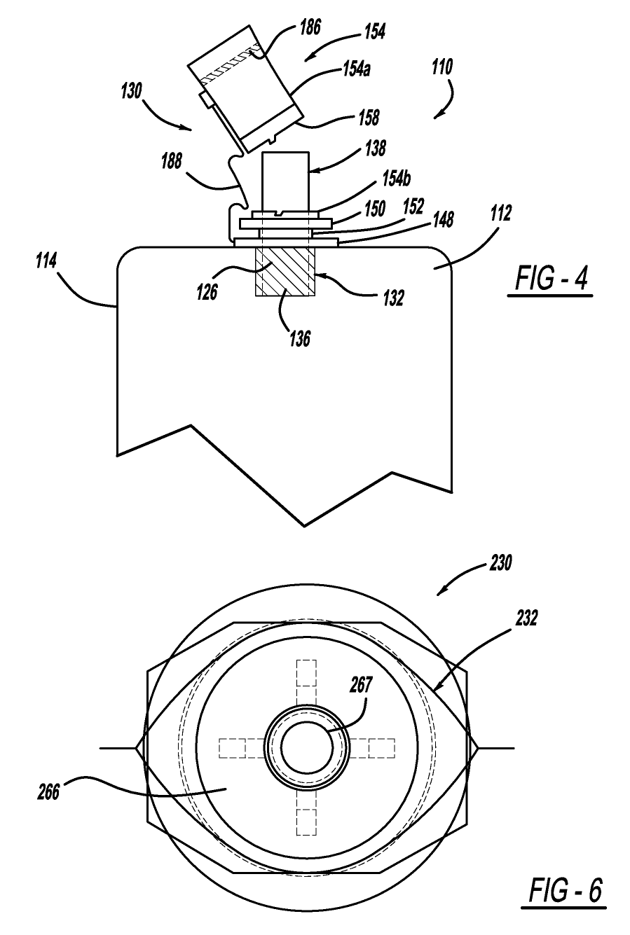

Referring to FIGS. 3 and 4, another example of a tube spout fitment 130 is illustrated. Like features have like reference numerals increased by 100. The internal tube spout fitment 130 includes a base portion 132 having a wall that is cylindrical in shape. The sealing surface of the base wall may include the previously described rings 146. The rings 146 may include a finger portion 146a extending beyond the wall of the base portion 132. The finger portion 146a provides additional sealing surface area, and improves the seal between the base portion 132 to the walls 112, 114 of the pouch. The fitment 130 includes an internal tube spout 138 extending upwardly from the base portion 132, as previously described. The internal tube spout 138 is a cylindrically shaped tube with a central passageway 140 that is integrally connected to the central passageway 138 in the base portion 132. The internal tube spout 138 advantageously has an ergonomic shape for drinking purposes. The fitment 130 may include the other features previously described, including a first flange 148, or a second flange 150. The external tube 154 is similar to the previously described internal tube spout 138. The base portion 132 is sealed between the walls 112, 114 of the pouch 110 using an ultrasonic seal 126, as previously described. The ultrasonic seal 126 advantageously provides a secure seal. The size of the base portion may be reduced using an ultrasonic seal.

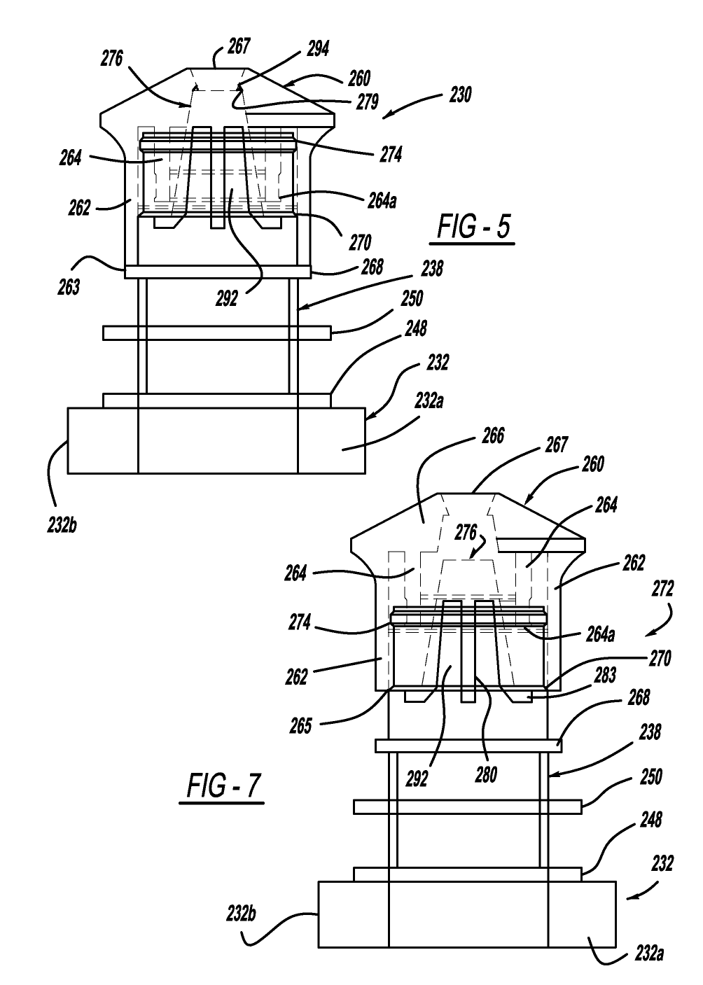

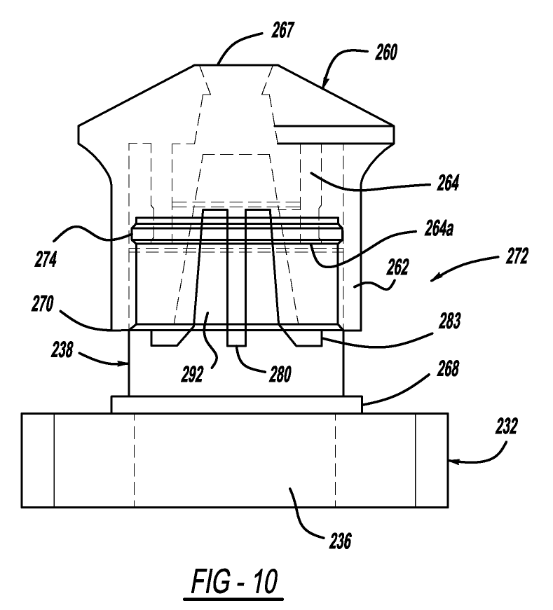

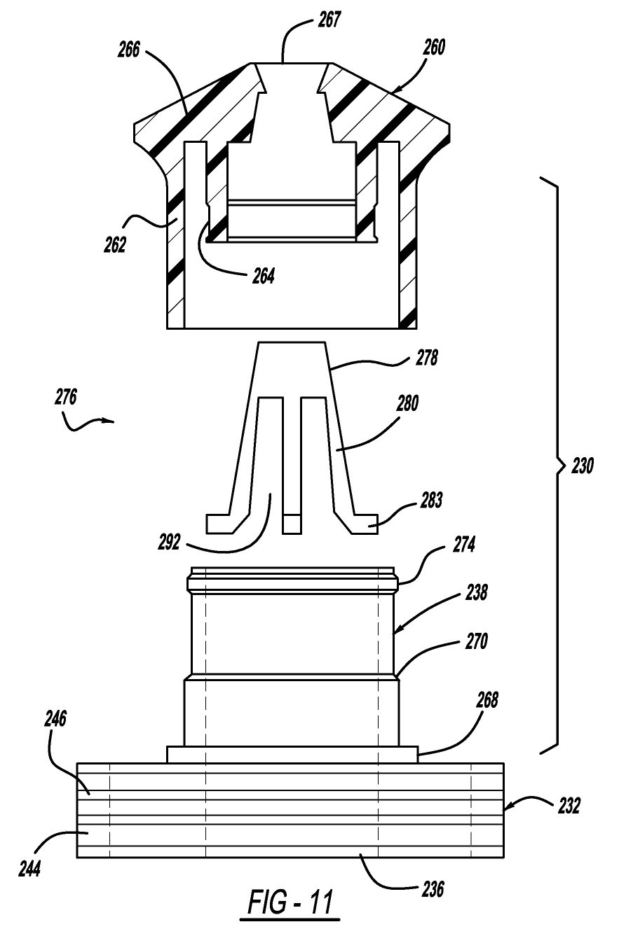

Referring to FIGS. 5-10, another embodiment of an internal tube fitment 230 with a slidable push-pull cap 260 is illustrated. Like features include like reference numerals to the previous embodiments increased by 200. The fitment 230 includes a base portion 232 as previously described. The base portion 232 includes a front wall 232a, a back wall 232b, and an internal tube spout 238, with a first flange 248 and a second flange 250. The push-pull cap 260 is slidable along the tube spout fitment between a closed position and an open position, to provide access to the product contained therein. The push-pull cap 260 may be secured to the internal tube spout by a separating means 258, as previously described. The separating means 258 is severed when the push-pull cap 260 is initially opened.

In addition, the internal tube spout 230 includes a third flange 268 spaced a predetermined distance above the second flange 250. The third flange 268 serves as a lower stop for the cap 260 in a closed position, as shown in FIG. 5. The internal tube spout 238 also includes a fourth flange 270 spaced a predetermined distance above the third flange 268. The fourth flange 270 provides a stop for a plug and an upper stop for the cap in an open position, as shown in FIG. 7 at 272. The uppermost edge of the internal tube spout may include a fifth flange 274 that provides a second stop for the cap 260 in an open position.

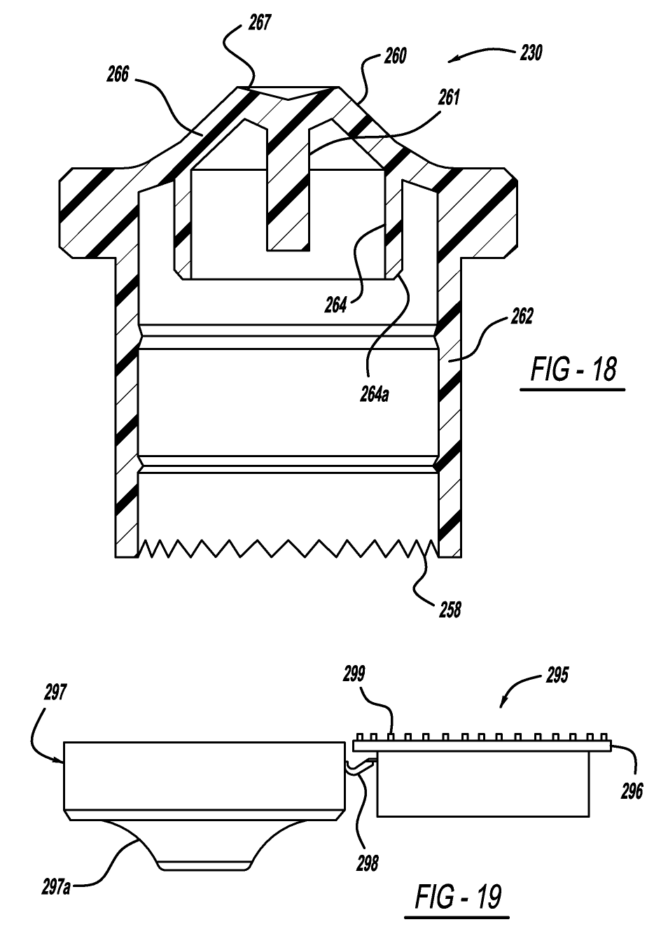

The slidable, push-pull cap 260 is a generally cylindrical member. The slidable push-pull cap 260 includes an outer wall 262, and an inner wall 264 that is generally parallel to the outer wall 262. In this example, the outer wall 262 is longer in length than the inner wall 264. An upper wall 266 interconnects the outer wall 262 and inner wall 264, and includes a central opening 267. As shown in FIG. 18, a pin member 261 is connected to a chamfered edge of the central opening 267 via a plurality of spaced apart wall sections 269 that define a plurality of apertures 271. The pin member 261 projects longitudinally between the inner wall 264 of the cap 260. The free end of the pin 261 may have a predetermined shape, such as spherical. The pin 261 is disposed within the plug 276 when the push-pull cap 260 is in a closed position, to provide additional leakage protection. The product is dispensed through the aperture 271 in the central opening 267 in the upper wall 266 when the push-pull cap 260 is in an open position. A lower edge of the outer wall 262 initially rests against the third internal tube flange 268 when the push-pull cap 260 is in a closed position as shown at 263. The lower edge of the outer wall 262 is stopped by the fourth flange 270 when the cap 260 is in the open position as shown at 265, to retain the push-pull cap 260 on the tube spout fitment. Similarly, a lower end of the inner wall 264 includes a chamfered edge 264a that is initially above the fourth flange 270, and is stopped by the fifth flange 274 in an open position 272, to retain the push-pull cap 260 on the internal tube spout 238 while allowing access to the product.

The push-pull cap 260 includes a plug 276 for dispensing the product contained within the pouch 10. The plug 276 includes a center disc portion 278, and a plurality of legs 280 extending longitudinally from a lower edge of the center disc portion 278. The product flows through openings 292 formed between the legs 280 when the push-pull cap 260 is in an open position. A lower end of each leg 280 includes a foot portion 283 projecting radially from the leg 280. The foot portion 283 is locked in place by the fourth spout flange 270, to prevent removal of the plug 276 from the spout 238. The center disc portion 278 of the plug 276 is temporally sealed 294 to the push-pull cap 260. For example, a tack seal 294 is used to secure an upper edge 279 of the plug 276 to the inner wall 264 of the push-pull cap 260 and form an initial seal 294 between the plug 276 and the push-pull cap 260. The tack seal 294 may be a heat weld or the like. The heat weld may be continuous or discontinuous or the like.

It should be appreciated that the plug 276 may be preassembled to the push-pull cap 260. Advantageously, the pouch 10 can be filled through the internal tube spout 238 if the plug 276 is preassembled to the push-pull cap 260. The assembled push-pull cap 260 is secured over the internal tube spout 238 by pushing the cap 260 over the internal tube 238, so that the feet portion 283 of the plug leg 280 is retained by the fourth flange 270. The lower edge of the outer cap wall initially rests against the third flange 268. In operation, a force is applied to pull the push-pull cap 260 in an upwards direction so that it slides with respect to the internal tube spout 238, and the tack seal 294 between the plug and cap is broken. The product flows between the legs 292, and out through the opening 267 in the push-pull cap 260. The cap push-pull 260 is environmentally friendly since it is retained on the internal tube spout 238.

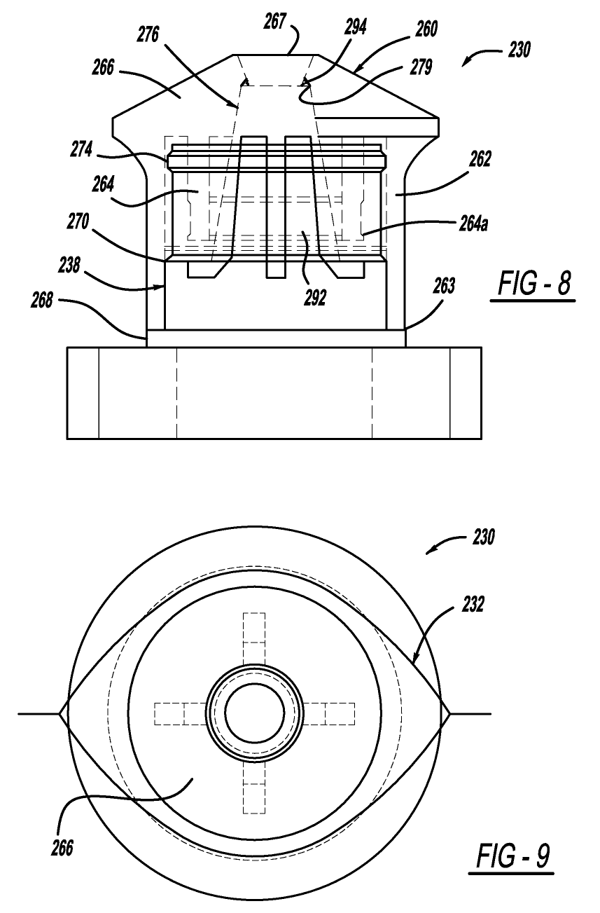

In still another embodiment illustrated in FIGS. 8-10 of the push-pull cap, the fitment 230 is similar to the previously described push-pull cap and fitment. However, in this example, the internal tube spout 234 only includes a third flange 268, fourth flange 270 and fifth flange 274, as previously described. The third, fourth and fifth flanges function as previously described.

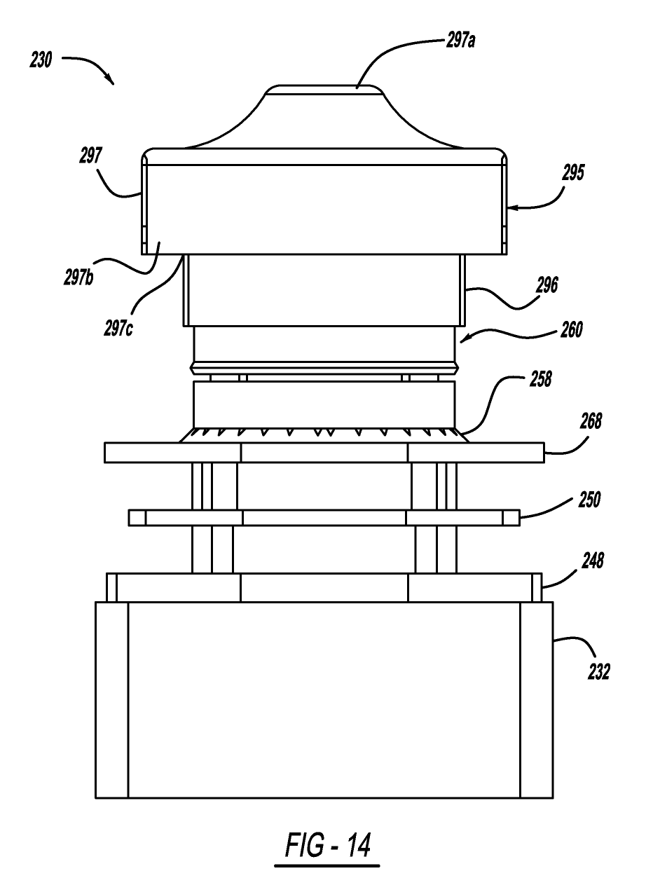

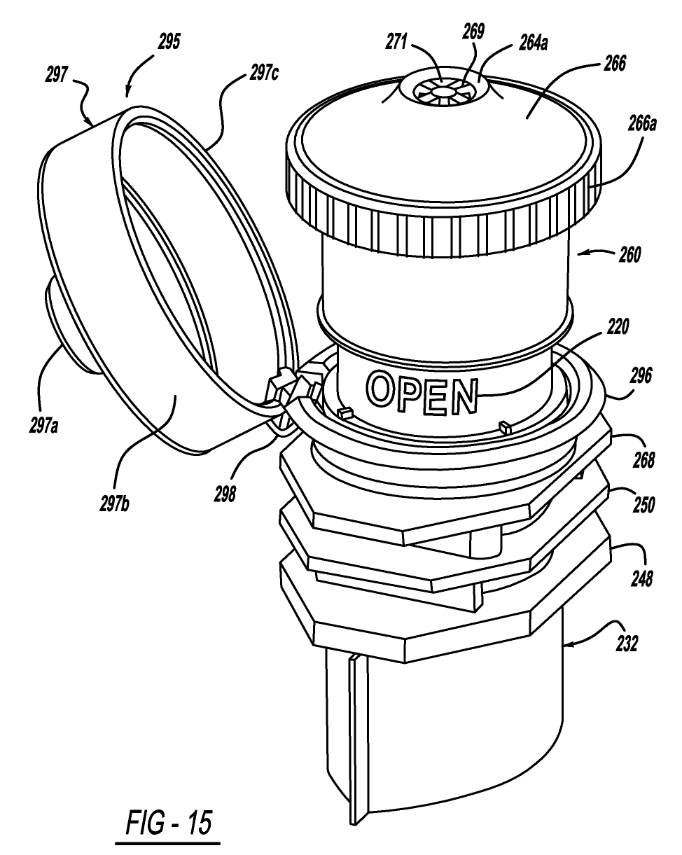

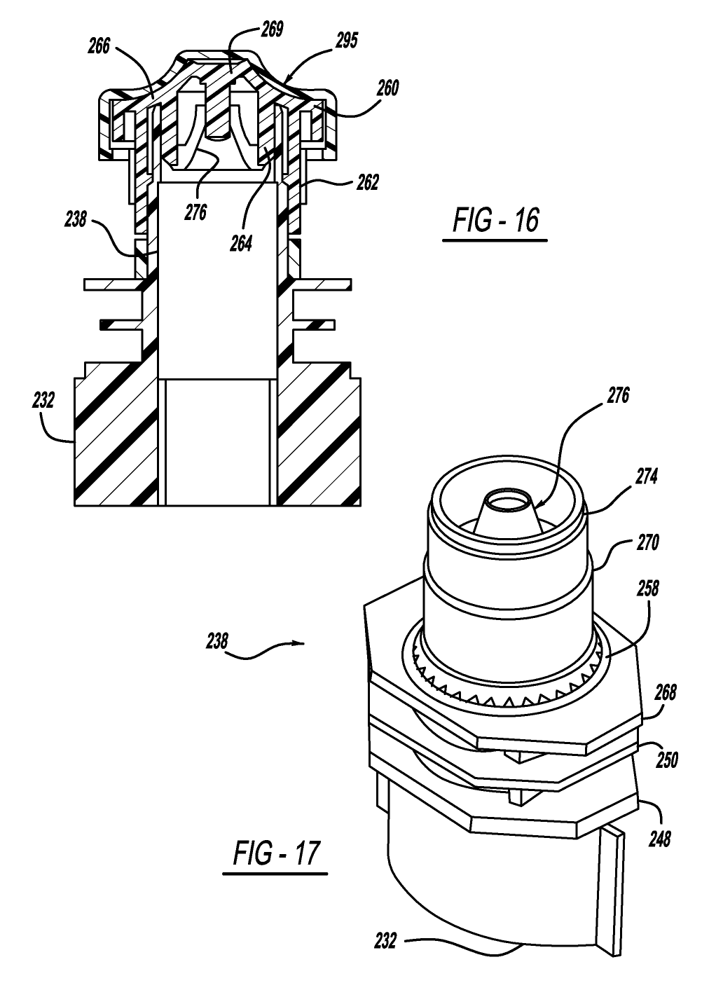

In still another example illustrated in FIGS. 14-18, the tube spout fitment 230 may include a tamper-evident feature. An example of a tamper-evident feature is an outer cap 295 that is initially secured over the slidable push-pull cap 260 and provides a visual indicator of prior access to the product within the pouch. The outer cap 295 includes an openable portion 297 that is openable to expose the push-pull cap 260, and a collar portion 296 that is permanently retained on a portion of the fitment 230. The openable portion 297 of the outer cap 295 is a cylindrical member having a closed end 297a, a wall 297b, and an open end defining a cavity for receiving the push-pull cap and fitment spout as shown at 297c. The openable portion 297 of the outer cap is connected to the collar 296 by a first connecting member 298. An example of a first connecting member 298 is a living hinge or the like. Another example of a first connecting member 298 is a tether 288, having one end secured to the openable portion 297 of the outer cap 295 and a second end connected to the collar portion 296. The openable portion 297 may be temporally connected to the collar portion 296 by a second connecting member 299. An example of a second connecting member 299 is a plurality of connecting walls 299 disposed between the openable portion 297 and the collar 296, and that interconnect the collar 296 and openable portion 297. The connecting walls 299 are thin wall sections that are severed upon the application of a predetermined force to the outer cap 295, in order to open the openable portion 297 of the outer cap 295 and uncover the slidable push-pull cap 260. The collar portion 296 is fixedly retained on the tube spout fitment 230 after the openable portion 297 of the outer cap 295 is opened. As shown in the example of FIG. 14 the collar portion 296 of the outer cap 295 may be fixedly retained by a corresponding surface of the push-pull cap 260, such as by a rib. In this example the outer cap 295 slides with the push-pull cap 260 in moving between an open and closed position of the push-pull cap. In another example shown in FIG. 15, the collar portion 296 may be displaceable with respect to the spout, and is retained on the tube spout 238 by a flange associated with the tube spout 238 or the slidable cap 260. The slidable push-pull cap 260 is displaceable with respect to the spout 238 between a closed position and an open position in order to access the product, while the collar portion 296 remains on the fitment 230.

The outer surface of the slidable cap 260 may include a plurality of gripping ribs 266a that assist a user in pushing or pulling the cap 260 with respect to the spout 234. In this example the gripping ribs 266a have a vertical orientation.

Another example of a tamper-evident feature is a visual indicator 220, such as a color code or words or the like. The visual indicator 220 is integrally formed in a portion of the push-pull cap 260 or internal tube spout 238. Exposing the visual indicator 220 causes a chemical change to the visual indicator, to provide evidence of tampering. For example, the visual indicator 220 is a material that changes color when exposed to air.

In operation, the outer cap 295 is initially pushed onto the spout 238 and retained by the engagement of the collar 296 with a portion of the fitment 230, such as the push-pull cap 260 or internal tube spout 238. To access the product for the first time, the user opens the cap by gripping the outer cap 295 by the outer surface of the openable portion 297 and applying a force to the cap 295 if necessary to sever any connecting walls 299 between the openable portion 297 and collar 296, to expose the slidable push-pull cap 260. Alternatively, the outer cap 295 may have a tab that is pulled to sever the connecting walls 299 to open the outer cap. To open the push-pull cap for the first time, the slidable cap 260 is displaced along the tube spout 234 between an open position and a closed position, to break the seal 294 between the plug 276 and the push-pull cap 260, so that the product can flow out of the spout 238, through the plug 276 and push-pull cap 260 as previously described. The separating means 258 between the push-pull cap and the internal tube spout may be initially severed. The push-pull cap 260 can be pushed in a downwards direction to close the spout. The openable portion 297 of the outer cap 295 can be reclosed, and the push-pull cap 260 is disposed within the cavity 297c formed in the outer cap 295. The outer cap 295 is environmentally friendly since it is permanently retained on the tube spout fitment.

The pouch may include other features, such as an ergonomic shape. An example of an ergonomically shaped pouch for a carbonated beverage is disclosed in commonly assigned U.S. patent application Ser. No. 11/454,241 which is incorporated by reference. The flexible pouch 10 may include a feature such as an outer layer or sleeve covering the outer surface of the pouch. The sleeve may be a label containing information about the product, such as a barcode or the like. The sleeve may cover only a portion of the pouch outer surface. Preferably, the sleeve is shrunk over the outer surface of the pouch 10 after the pouch 10 is formed and filled with the product. The sleeve is advantageous because it covers the side seam. It also adds one or more layers of material to strengthen the pouch and improve its durability. Various types of material may be utilized for the sleeve, such as paper or plastic including PET or PVC and the choice is non-limiting.

The pouch may include a hanging aperture formed in a seam for supporting the pouch by a support means. One or more hanging apertures may be formed along an edge of the pouch for receiving a clip. Advantageously attaching the pouch to the clip via the hanging aperture enhances the convenience of the flexible pouch.

The pouch 10 may include other features as a result of a secondary process after it is filled with the product. For example, the filled pouch 10 may be frozen. Alternatively, the filled pouch 10 may be pasteurized in order to have an extending shelf stable life under ambient temperature.

It is contemplated that the flexible pouch 10 may incorporate any of the above-described features in any combination. For example, the pouch 10 may include an insert in the bottom portion of the pouch and a tapered top portion, or an insert in the bottom portion of the pouch and a spout and cap in the top portion of the pouch. In addition, the finished pouch may assume various shapes, such as cylindrical, cubical, and conical, hourglass or barrel shaped or the like, as influenced by the type of product and intended usage of the pouch.

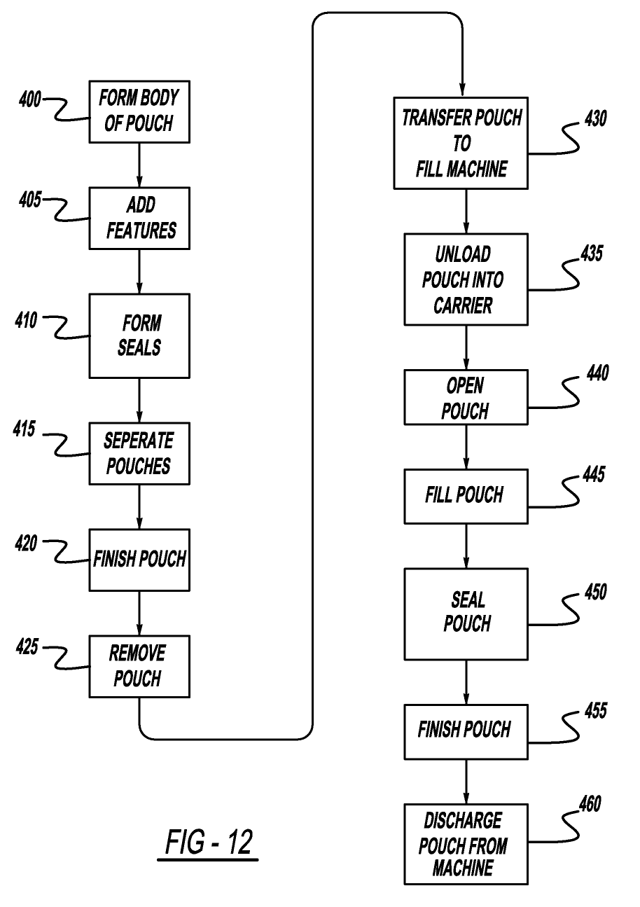

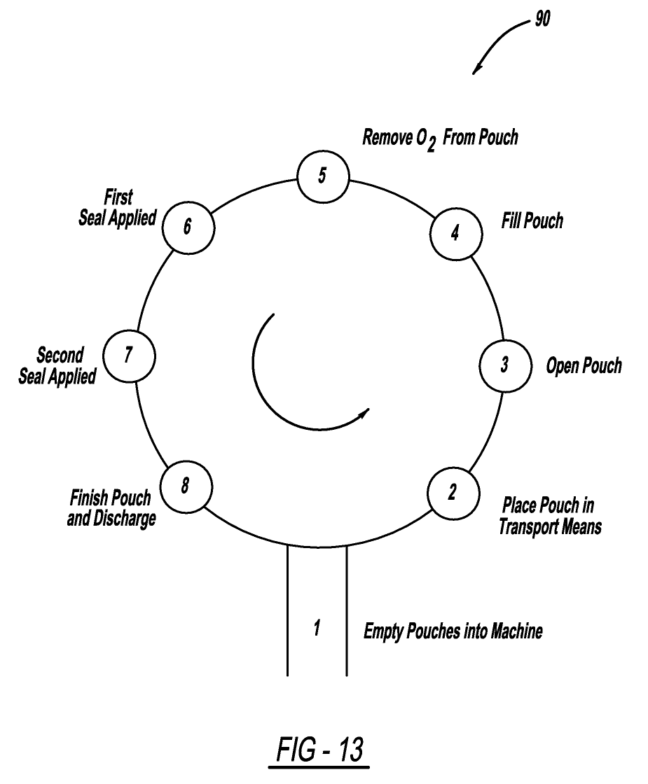

Referring to FIG. 12, a method for forming and filling the flexible pouch 10 using a high-speed machine 94, such as that described with respect to FIG. 13 is illustrated. The method begins in block 400 at a first station with the step of forming the body of the pouch 10. For example, a roll of laminate material, as previously described, is unrolled along a horizontally oriented plane. The initial width of the roll of material is determined by the desired finished size of the pouch 10 and the number of pouches to be obtained from the width. For example, three or four or six pouches, representing six to twelve panels, can be obtained from a width of the roll of material on a three-lane machine or four-lane machine, respectively. Each panel has an inner surface and an outer surface. One layer of the material is preferably preprinted with information or locating indicia (not shown), such as a registration mark. The registration marks are located on the material to denote an edge of the panel. The registration marks are read by an optical reading device (not shown), such as a scanner or registration eye, to index the material in a predetermined position at the cutting station. The preprinted information may include labeling information that describes the product contained within the pouch. In this example, the layer of preprinted information is located on an outer layer of the material. An example of a high speed, multiple lane machine for forming a pouch is described in commonly assigned U.S. patent application Ser. No. 11/674,923, which is incorporated herein by reference.

The methodology advances to block 405 and a feature, such as a gusset or insert, is optionally positioned between the aligned first and second unrolling sections of material. In addition, the fitment may be applied at this time if the pouch is filled through the inner tube fitment.

The methodology advances to block 410 and the edges of the walls are sealed together, such as the side edges, or the upper edge 16, or the lower edge 18. One edge may be left open for filling purposes. In this example, the open edge is designated the upper edge, as a reference. Alternatively, all of the edges are sealed and the pouch is filled through the fitment. An angled top seal may also be applied at this time. Various sealing techniques are contemplated. For example, an ultrasonic sealing process may be used. Another technique is a heat weld that includes the application of heat and compression. Advantageously, the seal may be shaped so as to avoid sharp radiuses at the interior corners of the pouch. A rounded interior shape facilitates removal of the product. A hanging aperture may be formed in a seam.

In still another example, the edges are sealed using a seal bar or forming plate having a plasma coating. One advantage of the plasma coating is that the line speed may increase. Another advantage is that the coating makes the surface of the seal bar or forming plate more resilient. When the seal bar is heated, the coating expands due to this resiliency. The shear stress on the inner edge of the seal is reduced; resulting in reduced creepage of the material and greater durability of the seal. The plasma coating reduces the opportunity for potential damage to the material during the sealing step. In this example, the plasma coating is a smooth, hard plastic that mimics glass. Since the outer layer of material is not weakened, there is no creepage of the outer layer.

In still another example of a sealing technique, the side seal is a two-step seal. An example of a two-step seal is disclosed in commonly assigned U.S. patent application Ser. No. 11/551,071. The two-step seal advantageously avoids the generation of ketones due to application of heat to the material. The first or inner seal is a low temperature seal. The second or outer seal is a high temperature seal. The second seal is spaced apart from the first seal by a predetermined distance, to create an air gap. The first seal is a tack seal, such as 6 mm wide, and is of a sufficient temperature so as to melt the layers of material and tack the edges together. The predetermined distance between the first and second seal is ½-1 mm. The second seal is applied at a higher temperature and pressure than the first seal. As a result, any gas, such as steam, ketones, aromatics or the like are pushed in an outwardly direction, out through the open edges of the panels, and not into the pouch. Thus, the first seal prevents entry of contaminates into the pouch to avoid organoleptic contamination.

The methodology advances to block 415, and a section of pouches formed in the roll width of material are separated from each other in a cutting operation. For example, each section of material may be first separated along its width, or the side seam of the pouches. The section is then separated into individual pouches. In this example, the width of unrolling material represents the side seams. The material is cut into a pouch 10 using a known cutting apparatus, such as a laser or punch or the like. The cutting apparatus forms a single cut in the material to separate the pouches. The size of the pouch 10 is controlled by the distance between the cuts.

Alternatively, two consecutive pouches 10 are separated using a double cutting process, whereby two cuts are made at the same time to separate the upper and lower edges of two pouches at the same time from the sheet of material. Advantageously, forming two pouches during the cutting operation effectively doubles the assembly line speed.

It should be appreciated that the upper edge or lower edge may be further trimmed. For example, the end of the pouch may be trimmed to accommodate a fitment. In another example, two legs are formed during the trimming operation, in order to recess the fitment. In still another example, the hanging aperture is formed in the pouch.

The methodology advances to block 420 and the pouch is finished; for example, a feature, such as the fitment, as previously described, may be sealed within the walls of the pouch 10, such as between the upper edges 16. The fitment may be sealed using an ultrasonic seal, or a heat weld, or by a combination of ultrasonic seal and heat weld, as previously described. An example of an ultrasonic seal for a fitment is disclosed in commonly assigned U.S. patent application Ser. No. 11/195,906, which is incorporated herein by reference. Accordingly, the base portion of the fitment is sealed between the walls of the pouch using an ultrasonic seal, a heat seal, and then a cool seal. The heat seal melts a layer of the pouch material, and the material flows around the sealing ribs on the base portion, and fills in any void between the base portion and the wall of the pouch. The cool seal sets the seal and provides an attractive finish to the overall seal. Advantageously, fewer stations are required to seal the fitment between the walls of the pouch, since a tack seal is eliminated.

In addition, an insert may be likewise applied to the pouch 10 at this time. The insert may be positioned at a lower edge of the pouch, an upper edge, or both an upper and lower edge. In another example, an edge of the pouch 10 may be trimmed to shape, i.e. the corners may be angled or edges trimmed fitment. It is sometimes advantageous for the pouch corners to have a radius, to eliminate right angles at the corners. A hanging aperture may be formed at this time. This operation may be performed using a cutter or a die cut or the like.

In another example of a finishing operation, a crease or guide pocket may be formed in a top portion of each wall 12, 14 in a creasing operation, in order to facilitate opening and filling of the pouch. An example of a method of forming a crease in a wall to facilitate opening the pouch is disclosed in commonly assigned U.S. patent application Ser. No. 10/310,221, which is incorporated herein by reference. It should be appreciated that the shape of the finished pouch is non-limiting, and may be round, square, oval, triangular or the like. In still another example of a finishing operation, the sleeve is applied over the individual pouch and shrunk to fit using an application of heat to the pouch. A further example of a finishing operation is the formation of a rib, such as a thermoformed rib, to add rigidity to the pouch.

The methodology advances to block 425 and the pre-made pouch 10 is discharged from the form machine. The pouches may be loaded into a carrier and transferred to a filling machine. It should be appreciated that the filling machine may be integral with the pouch forming machine, or a separate machine. This portability increases the flexibility of the pouch and may result in a manufacturing cost savings.

The methodology advances to block 430, and the pouch is then transported to the filling machine. In block 435 the pouch is placed in a holder for moving the pouch between stations. An example of a holder is a cup-shaped member, as disclosed in commonly assigned U.S. patent application Ser. No. 10/336,601, which is incorporated herein by reference. In another example, the pouch 10 may be held using grippers that grip the gripping portion 52 of the pouch 10 between the first and second flanges 48, 50 of the spout 34. In still another example, the gripping portion 52 of the pouch may be carried by a rail. The methodology advances to block 440.

In block 440, the pouch 10 is opened in an opening operation. Various techniques are conventionally known in the art for opening the pouch 10. For example, the guide pocket formed by the crease in the front wall 12 and back wall 14 facilitates opening of the pouch. A nozzle (not shown) may be mechanically lowered into the guide pocket to direct a stream of compressed gas into the guide pocket, to force the walls of the pouch 10 away from each other. An example of a gas is carbon dioxide or nitrogen. The blowing station may include a manifold, with a hood extending over the top of the edges of the pouch as known in the art. The manifold has rows of apertures (not shown) formed above the upper edges 16 of the pouch 10. The hood is placed over the pouch 10 to assist in maintaining the air pressure in the pouch 10. The supply of pressurized gas is directed through the aperture to form a plurality of jets of pressurized gas or air. The jets are directed downwardly at the diamond-shaped openings formed at the upper edges 16 to assist in overcoming the surface tension of the pouch and assist in separation of the walls 12, 14. A diving rod (not shown) may then be used to make sure the pouch 10 is fully opened. If the pouch has a fitment, the gas is injected through the spout fitment. After the pouch is opened, it may be injected with super-saturated steam to eliminate any pathogens or the like. The methodology advances to block 445.

In block 445, the pouch 10 is filled with the product in a filling operation. For example, a fill tube (not shown) is lowered into the opened pouch 10 and the product is dispensed into the open pouch 10. The pouch may be filled through an open edge, or through the internal tube spout 38, as previously described. If the pouch is large, the pouch may be filled at more than one station.

If the product is naturally carbonated, such as a sparkling wine or the like, the pouch is preferably filled while immersed in a nitrogen or carbon dioxide atmosphere. If the product is not naturally carbonated and carbonation is desirable, it is immersed in a carbonator to introduce carbon dioxide into the product. For example, carbon dioxide is introduced into cold water or juice to provide a carbonated beverage. The product may contain a mixture of up to four volumes of carbon dioxide. It should be appreciated that the carbon dioxide masks any undesirable taste from ketones and other solvents released during the sealing process. The carbon dioxide also increases the pressure within the product so that the walls of the pouch are rigid after the top is sealed. The product is preferably filled at a temperature ranging from 29° F. to ambient temperature.

The filled pouch may have the oxygen removed from the pouch. For example, the pouch may be flushed with carbon dioxide. The methodology advances to block 450.

In block 450, the pouch is sealed. For example, if the pouch is filled through the open edges, the open edges of the pouch are closed by applying a first closing seal. The first closing seal may be an ultrasonic seal, or an ultra pulse seal. An example of a closing seal for a pouch containing a carbonated beverage, is described in commonly owned PCT Patent Application No. PCT/US03/034396 which is incorporated herein by reference. A second seal may be applied a predetermined distance apart from the first seal for a carbonated product. The second seal may be a heat weld or a cosmetic seal or an ultrasonic seal or the like. The location of the second seal is selected so that some of the product is trapped between the first and second seals. This is advantageous since it eliminates the potential for gas in the head space, i.e. the region between the product and the heat seal. In this example the second seal is spaced outboard of the first seal. Another advantage of the location of the second seal is that the overall length of the pouch may be reduced, resulting in less pouch material. The first closing seal is a tack seal, and the second closing seal is a high pressure, high temperature seal. A cosmetic seal may be applied with respect to the first and second closing seals, or the second seal may be a cosmetic seal.

Alternatively, the pouch is filled through the internal tube spout fitment 30, 230 and the cap 60, 260 or external tube 54 is secured over the internal tube 38, 238, as previously described, to close the pouch 10. The cap 60, 260 or external tube 54 contains the product in the filled pouch 10, to prevent leakage of the product from the pouch 10. In the example of an external tube 54, tube 54 is pushed on the internal tube spout 38 and retained as previously described. In an example of a push-pull cap, the plug is preassembled to the push-pull cap and the plug and push-pull cap are pushed onto the spout and retained by the spout. A tamper-evident outer cap 295 may be disposed over the external tube 54 or slidable cap 260 and fixedly retained by the tube spout fitment 230 as previously described. It should be appreciated that the tamper-evident outer cap 295 may be pre-assembled to the slidable cap 260. This operation is advantageous because it is fast, and cost efficient since it can be done at a high speed. In the example of an open-ended external tube, the open end 82 of the tube is sealed by applying a closing seal to the upper edges of the cap. The closing seal may be an ultrasonic seal, or an ultra pulse seal 86, such as a heat weld or the like.

The methodology advances to block 455 and the pouch 10 is finished in a finishing operation. For example, the edges of the pouch 10 are trimmed to achieve a predetermined shape. In addition, the pouch 10 may be cooled at a cooling station, where the pouch 10 is cooled using a conventionally known cooling technique. Optionally, the sleeve may be placed over the filled pouch and shrunk to fit over the pouch by applying heat. The sleeve layer forms an outer layer of the pouch. The methodology advances to block 460.

In block 460 the filled pouch 10 is discharged from the machine. A plurality of pouches may be placed in a package for sales or shipping purposes. A plurality of pouches may be placed in a package for sales or shipping purposes. The pouch may be discharged back into a carrier rack for storage or into a case packed for shipping.

It should be appreciated that the pouch may undergo other processing steps, such as such as an upstream oxygen purging station, downstream oxygen purging station, pasteurization or the like. For example, the filled pouch 10 may be pasteurized in an integral retort chamber (not shown) that heats and then cools the pouch 10. The pouch 10 may be tested, such as burst testing or the like prior to packaging for shipping. These additional processing steps may take place at a station on the form/fill/seal apparatus, or on another apparatus.

It should be appreciated that the order of steps may vary depending on the pouch and its features. Also, a particular manufacturing station may perform one or a plurality of operations, to enhance the efficiency of the methodology and apparatus.

Referring to FIG. 13, an example of a fill-seal machine 90 for carrying out the method described with respect to FIG. 12 is illustrated. The fill machine 90 illustrated is by way of example, and other configurations may be utilized. It should be appreciated that a particular manufacturing station may perform one or more operations. It should also be appreciated that the order of operations may vary. The fill-seal machine may be configured as a flat bed, a conveyor, a rotary turret or the like. An example of a flat bed form machine is manufactured by Nishibe, such as the model number SBM500, SMB600 or SMB700. It should be appreciated that the fill-seal machine may be integral with the form machine, or a separate machine.

In operation, the carrier with the pouch is loaded onto the machine as shown at “1”. The pouches 10 are removed from the receptacle and placed in a transport means as shown at “2”. The transport means may be a carrier or a gripper or a rail or a combination thereof.

The pouch 10 is transported along the conveyor belt to operation “3”, and the pouch 10 is opened in an opening operation. Various techniques are conventionally known in the art for further opening the pouch 10. For example, nozzle may be mechanically lowered into the pouch to direct a stream of compressed gas downwardly into the pouch to force the walls of the pouch away from each other to further open an upper edge of the pouch. An example of a gas is carbon dioxide or nitrogen. The lever arms assist in maintaining the pouch in an open position.

The pouch 10 is then fully opened. For example, a blowing station may include a manifold, with a hood extending over the top of the edges of the pouch. The manifold has rows of apertures (not shown) formed above the upper edges of the walls of the pouch. The hood is placed over the pouch to assist in maintaining the air pressure in the pouch. The supply of pressurized gas is directed through the aperture to form a plurality of jets of pressurized gas or air. The jets are directed downwardly at the diamond-shaped openings formed at the upper edges to assist in overcoming the surface tension of the walls and assist in separation of the walls. A diving rod may then be used to make sure the pouch is fully opened.

The opened pouch is transferred to a filling station as indicated at operation “4”, and the pouch is filled with the product. For example, a nozzle dispenses a predetermined amount of product into the opened pouch. The product may be dispensed into the opened edges of the pouch or through the inner tube fitment. In this example, the fill nozzle is lowered into the opened pouch, and the product is dispensed into the open pouch. Depending on the size of the pouch, there may be two fill stations.

If the product is naturally carbonated, such as with a sparkling wine or another alcoholic beverage, the pouch is preferably filled while immersed in a nitrogen atmosphere or carbon dioxide atmosphere. The pouch may be flushed with nitrogen or carbon dioxide or a mixture of both. If the product is not naturally carbonated, it may be immersed in a carbonator to introduce carbon dioxide into the product. For example, carbon dioxide is introduced into cold water or juice to provide a carbonated beverage. The product may contain a mixture of up to four volumes of carbon dioxide. It should be appreciated that the carbon dioxide masks any undesirable taste from ketones and other solvents released during the sealing process. The carbon dioxide also increases the pressure within the product so that the walls of the pouch 10 are rigid after the top is sealed. The product is preferably filled at a temperature ranging from 29° F. to ambient temperature. The carbonation is advantageous as a microbiocide which can enhance the flavor or prevent mold or contamination.

The pouch 10 is transferred to a station “5” for removing any oxygen from the pouch. The headspace of the pouch may be flushed with a gas.

The pouch is then transferred to a sealing station and if filled through the open edges of the pouch, the open edges of the pouch are first sealed, as indicated at operation “6”. For example, at the sealing station “6”, the lifting surface ends, causing the lever arms to return to their original position and the pouch to close. It should be noted that the filled pouch might return to a partially closed position due to the product contained therein. The first seal may be a thermal seal. For example, a heat-sealing member extends through the slots in the sides of the cup to seal the upper edge of the pouch. As previously described, the heat-sealing member may have a plasma coating. For example, a heat-sealing member extends therethrough the slots in the sides of the cup, to seal the upper edge of pouch. For example, at the sealing station “6”, the lifting surface ends, causing the lever arms to return to their original position, and the pouch to close. It should be noted that the filled pouch might return to a partially closed position due to the product contained therein.

Another example of a first seal for a product utilizes an ultrasonic sealing process. Preferably the ultrasonic seal includes sound waves and is formed using a horn and anvil. A second seal is applied at a second sealing station “7”. The second seal may be applied using a heat seal means to form a second heat seal spaced apart a predetermined distance from the first seal. It should be appreciated that the second seal may be spaced slightly outboard of the first seal, in order to trap some of the product between the two seals. The second heat-sealing station is conventional and utilizes heat or a combination of heat and pressure to form the seal. The second seal may also be a cosmetic seal or another type of seal, such as ultrasonic, ultra pulse or the like. The first and second seals are applied for a carbonated product as disclosed in commonly assigned Patent Application No. PCT/US03/34396, which is incorporated herein by reference.

If the pouch is filled through the tube spout fitment 38, 238 the pouch 10 is closed by securing a cap 260 or tube 54 to the fitment. As previously described, the cap 260 or external tube 54 may be pushed onto the tube spout fitment and is retained thereon. The cap 260 may have a tamper-evident feature, such as an environmentally friendly outer cap 295. The cap 260 and fitment may have leak-proof features as previously described for a carbonated product. Advantageously, only a seal bar is required to heat seal the top of the internal tube closed.

The pouch is transferred to a finishing station as shown at “8” for finishing and removal from the filling machine. For example, the pasteurized pouch 10 may be cooled. A hanging aperture may be formed at this time. In another finishing operation, the edges of the pouch are trimmed to achieve a desired shape. The finished pouches may be discharged into a container. For example, grippers may be utilized to place the pouch in a box for shipment.

If desired, the pouch may be transferred to a pasteurization station. Pasteurization enhances the shelf life of the product. The pouch is inserted into an enclosed retort chamber. Air is extracted from the chamber, such as using a vacuum source. The product inside the pouch is pasteurized. For example, a combination of steam and water is used to heat the pouch to a predetermined temperature for a predetermined period of time to pasteurize the product contained within the pouch. The package is then cooled. In this example, recirculated water surrounds the pouch to cool the pouch. In certain instances, it may be desirable to apply steam to sterilize the pouch 10 and to wet the inner surface of the walls to facilitate handling.

The present invention has been described in an illustrative manner. It is to be understood that the terminology which has been used is intended to be in the nature of words of description rather than of limitation.

Many modifications and variations of the present invention are possible in light of the above teachings. Therefore, the present invention may be practiced other than as specifically described.

1. A tamper-evident outer cap for a tube spout fitment with push-pull cap comprising:
a panel of flexible material forming a body of the pouch;
a tube spout fitment sealed to the pouch body, wherein the tube spout fitment includes a base portion having a seal-engaging surface that is disposed within the pouch body and a centrally located passageway within the base portion, and an internal tube spout projecting upwardly from the base portion and having a centrally located passageway that is continuous with the base portion passageway;
a push-pull cap slideably retained on the internal tube spout, wherein the push-pull cap is a generally cylindrical member having an outer wall, an inner wall parallel to the outer wall, and an upper wall having a central opening formed therein interconnecting the outer wall to the inner wall; and
a tamper-evident outer cap disposed over the push-pull cap, wherein the outer cap includes an openable portion, a collar portion permanently retained on the tube spout fitment, and a first connecting member interconnecting the openable portion and the collar portion.

2. The tamper-evident cap of claim 1 wherein the openable portion is temporally connected to the collar portion by a second connecting member.

3. The tamper-evident cap of claim 2 wherein the second connecting member is a plurality of severable connecting walls temporally interconnecting the openable portion of the tamper-evident cap with the collar portion.

4. The tamper-evident cap as set forth in claim 1 wherein the tamper-evident outer cap is a cylindrical member having a closed end and an open end defining a cavity for receiving the push-pull cap therein in a closed position.

5. The tamper-evident cap of claim 1 wherein the collar portion of the outer cap is displaceable with respect to the tube spout in an open position, and is retained on the tube spout fitment by the push-pull cap.

6. The tamper-evident cap of claim 1 wherein the first connecting member is a tether having one end secured to the openable portion of the tamper-evident cap and a second end secured to the collar portion of the tamper-evident cap.

7. The tamper-evident of claim 1 wherein the first connecting member is a hinge having one end secured to the openable portion of the tamper-evident cap and a second end secured to the collar portion of the tamper-evident cap.

8. The tamper-evident cap as set forth in claim 1 wherein the tube spout fitment includes a visual indicator that signals an initial opening of the tamper-evident outer cap.

9. The tamper-evident cap of claim 1 further comprising:
a plug disposed within the push-pull cap and temporarily sealed to the push-pull cap, wherein the plug includes a disc and a plurality of legs extending from an outer edge of the disc, and the outer edge of the disc is temporarily sealed to the push-pull cap, such that initially pulling the push-pull cap breaks the temporary seal between the plug and the push-pull cap, so that the product flows out through an opening formed between the plug legs and through a central opening in the upper wall of the cap;
a first flange extending radially from the internal tube spout and positioned adjacent the seal-engaging surface of the base portion;
a second flange extending radially from the internal tube spout and spaced a predetermined distance above the first flange, and a portion of the internal tube spout therebetween the first flange and the second flange provides a gripping surface;
a third flange extending radially from the internal tube spout and positioned adjacent the seal-engaging surface of the base portion, and a fourth flange extending radially from the internal tube spout and spaced a predetermined distance above the third flange, and a fifth flange extending radially from the internal tube spout and spaced a predetermined distance above the fourth flange; and
a lower edge of the push-pull cap outer wall is adjacent the third spout flange when the push-pull cap is in a closed position and the lower edge of the push-pull cap outer wall is stopped by the fourth flange when the push-pull cap is in the open position, and a lower edge of the push-pull cap inner wall is stopped by the fifth flange when the push-pull cap is in the open position, to retain the push-pull cap on the internal tube spout.

10. The tamper-evident cap of claim 9 wherein a tack weld temporarily seals the plug to the push-pull cap.

11. The tamper-evident cap of claim 10 wherein the plug is first sealed to the push-pull cap and the push-pull cap and plug are pushed onto the internal tube spout.

12. A tamper-evident outer cap for a tube spout fitment with push-pull cap disposed in a flexible pouch comprising:
a panel of flexible material forming a body of the pouch;
a tube spout fitment sealed to the pouch body, wherein the tube spout fitment includes a base portion having a seal-engaging surface that is disposed within the pouch body and a centrally located passageway within the base portion, and an internal tube spout projecting upwardly from the base portion and having a centrally located passageway that is continuous with the base portion passageway;
a push-pull cap slideably retained on the internal tube spout and operable between a closed position and an open position, wherein the push-pull cap is a generally cylindrical member having an outer wall, an inner wall parallel to the outer wall, and an upper wall having a central opening formed therein and interconnecting the outer wall to the inner wall;
a plug disposed within the push-pull cap and temporarily sealed to the push-pull cap, wherein the plug includes a disc and a plurality of legs extending from an outer edge of the disc, and the outer edge of the disc is temporarily sealed to the push-pull cap, such that initially pulling the push-pull cap breaks the temporary seal between the plug and the push-pull cap, so that the product flows out through an opening formed between the plug legs and through a central opening in the upper wall of the cap;
a tamper-evident outer cap disposed over the push-pull cap, wherein the outer cap includes an openable portion that opens to expose the push-pull cap and the openable portion is a cylindrical member having a closed end and an open end forming a cavity for receiving the push-pull cap therein, a collar portion permanently retained on the tube spout fitment, and a first connecting member interconnecting the openable portion and the collar portion and the first connecting member is a hinge having one end secured to the openable portion of the tamper-evident outer cap and a second end secured to the collar portion of the tamper-evident outer cap; and
a second connecting member interconnecting the openable portion and the retained portion of the tamper-evident outer cap, wherein the second connecting member means is a plurality of severable connecting walls initially interconnecting the openable portion of the tamper-evident cap and the collar portion.

13. The flexible pouch as set forth in claim 12 wherein the tube spout fitment includes a visual indicator that signals an initial removal of the tamper-evident outer cap from covering the push-pull cap.

14. The flexible pouch of claim 12 where the internal tube spout includes a first flange extending radially from the internal tube spout and positioned adjacent the seal-engaging surface of the base portion, and a second flange extending radially from the internal tube spout and spaced a predetermined distance above the first flange, and a portion of the internal tube spout therebetween the first flange and the second flange provides a gripping surface for supporting the flexible pouch;
a third flange extending radially from the internal tube spout and positioned adjacent the seal-engaging surface of the base portion, and a fourth flange extending radially from the internal tube spout and spaced a predetermined distance above the third flange, and a fifth flange extending radially from the internal tube spout and spaced a predetermined distance above the fourth flange; and
a lower edge of the push-pull cap outer wall is adjacent the third spout flange when the push-pull cap is in a closed position and the lower edge of the push-pull cap outer wall is stopped by the fourth flange when the push-pull cap is in the open position, and a lower edge of the push-pull cap inner wall is stopped by the fifth flange when the push-pull cap is in the open position, to retain the push-pull cap on the internal tube spout.

15. The tamper-evident cap of claim 12 wherein the collar portion of the outer cap is displaceable with respect to the tube spout in an open position, and is retained on the tube spout fitment by the push-pull cap.

16. The tamper-evident cap of claim 12 wherein the tube spout fitment includes a visual indicator that signals an initial opening of the tamper-evident cap.

17. The tamper-evident cap of claim 12 wherein the plug is first sealed to the push-pull cap and the push-pull cap and plug are pushed onto the internal tube spout.

18. A method of forming a flexible pouch having a tamper-evident outer cap for a tube spout fitment with push-pull cap, said method comprising the steps of:
forming a body of the pouch from a panel of flexible material;
sealing a tube spout fitment to the pouch body, wherein the tube spout fitment includes a base portion having a seal-engaging surface that is disposed within the pouch body and a centrally located passageway within the base portion, and an internal tube spout projecting upwardly from the base portion and having a centrally located passageway that is continuous with the base portion passageway;
filling the pouch with a product;
temporarily sealing a plug to a push-pull cap, wherein the push-pull cap is a generally cylindrical member having an outer wall, an inner wall parallel to the outer wall, and an upper wall having a central opening formed therein and interconnecting the outer wall to the inner wall and the plug includes a disc and a plurality of legs extending from an outer edge of the disc, and the outer edge of the disc is temporarily sealed to the push-pull cap;
pushing the push-pull cap and plug onto the internal tube spout so that it is slidable between a closed position and an open position;
placing a tamper-evident outer cap over the push-pull cap, wherein the outer cap includes an openable portion that opens to expose the push-pull cap and the openable portion is a cylindrical member having a closed end and an open end forming a cavity for receiving the push-pull cap therein, a collar portion permanently retained by the tube spout fitment, a first connecting member interconnecting the openable portion and the collar portion and the first connecting member is a hinge having one end secured to the openable portion of the tamper-evident outer cap and a second end secured to the collar portion of the tamper-evident outer cap and a second connecting means interconnecting the openable portion and the collar portion of the tamper-evident outer cap; and
opening the tamper-evident outer cap and initially pulling the push-pull cap breaks the temporary seal between the plug and the push-pull cap, so that the product flows out through an opening formed between the plug legs and through a central opening in the upper wall of the cap.

19. The method of claim 18 wherein the tube spout fitment includes a visual indicator that signals an initial opening of the tamper-evident cap.

20. The method of claim 18 wherein the second connecting means is a plurality of severable connecting walls initially interconnecting the openable portion of the tamper-evident cap with the collar portion.
